(19) United States
(12) Patent Application Publication
(10) Pub. No.: US 2021/0284089 A1
(43) Pub. Date: Sep. 16, 2021

(54) SYSTEM, IN-VEHICLE DEVICE, AND INFORMATION PROCESSING

(71) Applicant: TOYOTA JIDOSHA KABUSHIKI KAISHA, Toyota-shi (JP)

(72) Inventors: Tomonari YAMAGUCHI, Miyoshi-shi (JP); Masanori KUSHIBE, Toyota-shi (JP)

(73) Assignee: TOYOTA JIDOSHA KABUSHIKI KAISHA, Toyota-shi (JP)

(21) Appl. No.: 17/193,561

(22) Filed: Mar. 5, 2021

(30) Foreign Application Priority Data
Mar. 13, 2020 (JP) 2020-043684

(51) Int. Cl. B60R 16/037; H04W 12/06; H04W 4/40; B60W 40/08

(52) U.S. Cl. CPC B60R 16/037; H04W 12/06; B60W 2556/45; B60W 40/08; B60W 2540/043; H04W 4/40

(57) ABSTRACT

An in-vehicle device receives first information which is a part of individual setting information of a user related to pieces of equipment provided in the vehicle from a user terminal owned by the user by short-range wireless communication. The in-vehicle device receives second information other than the first information in the individual setting information from a server device through a network. Then, the in-vehicle device transmits, to an equipment control device, the first information received from the user terminal and the second information received from the server device.

### CROSS REFERENCE TO THE RELATED APPLICATION

This application claims the benefit of Japanese Patent Application No. 2020-043684, filed on Mar. 13, 2020, which is hereby incorporated by reference herein in its entirety.

### BACKGROUND

### Technical Field

The present disclosure relates to a technique for customizing settings of pieces of equipment, mounted on a vehicle.

### Description of the Related Art

Japanese Patent Laid-Open No. 2012-218454 discloses a technique related to an in-vehicle environment information sharing system. In the system disclosed in Japanese Patent Laid-Open No. 2012-213454, an in-vehicle environment estimation unit estimates in-vehicle environment information desired by a user based on a set value set by the user in one vehicle of a plurality of vehicles. Additionally, a storage stores, therein, the in-vehicle environment information estimated by the in-vehicle environment estimation unit in association with the user. Furthermore, a customization information conversion unit converts the in-vehicle environment information stored in the storage to conform to another vehicle among the plurality of vehicles.

### SUMMARY

The present disclosure has an object to provide a technique capable of more preferably customizing various settings in pieces of equipment mounted on a vehicle.

A system according to a first aspect of the present disclosure is a system comprising a user terminal, a server device, and an in-vehicle device mounted on a vehicle, wherein first information which is a part of individual setting information of a user related to pieces of equipment provided in the vehicle is stored in the user terminal owned by the user, second information other than the first information in the individual setting information is stored in the server device, the user terminal transmits the first information to the in-vehicle device by short-range wireless communication, the server device transmits the second information to the in-vehicle device through a network, and the in-vehicle device transmits the first information received from the user terminal and the second information received from the server device to an equipment control device that controls the pieces of equipment provided in the vehicle.

An in-vehicle device according to a second aspect of the present disclosure is an in-vehicle device mounted on a vehicle comprising a controller configured to perform receiving first information which is a part of individual setting information of a user, related to pieces of equipment provided in the vehicle from a user terminal owned by the user by short-range wireless communication, receiving second information other than the first information in the individual setting information from a server device through a network, and transmitting the first information received from the user terminal and the second information received from the server device to an equipment control device that controls the pieces of equipment provided in the vehicle.

An information processing method according to a third aspect of the present disclosure is an information processing method performed by a computer in a system comprising a user terminal, a server device, and an in-vehicle device mounted on a vehicle, the method comprising transmitting first information which is a part of individual setting information of a user related to pieces of equipment provided in the vehicle to the in-vehicle device from the user terminal owned by the user by short-range wireless communication, transmitting second information other than the first information in the individual setting information from the server device to the in-vehicle device through a network, and causing the in-vehicle device to transmit the first information received from the user terminal and the second information received from the server device, to an equipment control device that controls the pieces of equipment provided in the vehicle.

According to the present disclosure, various settings in pieces of equipment mounted on a vehicle can be customized more preferably.

### BRIEF DESCRIPTION OF THE DRAWINGS

FIG. 1 is a diagram illustrating a schematic configuration of an information management system that manages individual setting information for customizing a vehicle, according to the present embodiment;

FIG. 2 is a diagram illustrating a schematic configuration of an in-vehicle device and ECUs that control pieces of equipment provided in a vehicle;

FIG. 3 is a diagram illustrating specific examples of pieces of equipment to be customized based on the individual setting information and setting items;

FIG. 4 is a block diagram schematically illustrating an example of a functional configuration of each of a user terminal, an in-vehicle device, and a management server;

FIG. 5 is a sequence diagram illustrating an information process flow in the information management system according to a first embodiment;

FIG. 6 is a table illustrating an example of a table configuration of the individual setting information database according to modified embodiment 2 of the first embodiment; and

FIG. 7 is a sequence diagram illustrating an information process flow in an information management system according to a second embodiment.

### DESCRIPTION OF THE EMBODIMENTS

A system according to a first aspect of the present disclosure includes a user terminal, a server device, and an in-vehicle device. The user terminal is a terminal owned by a user who uses the system. The in-vehicle device is a device mounted on a vehicle that the user who uses the system is going to get into. Additionally, the server device is a device capable of communicating with the user terminal and the in-vehicle device through a network.

Individual setting information of the user who is going to get into the vehicle is stored in the user terminal and the server device. The individual setting information is information for performing various settings in pieces of equipment provided in the vehicle. That is, the individual setting information is information for customizing, when the user has gotten into the vehicle, the various settings in the pieces of equipment provided in the vehicle to the settings corresponding to the user having gotten into the vehicle.

Here, first information which is a part of the individual setting information is stored in the user terminal. Additionally, second information which is information other than the first information in the individual setting information is stored in the server device. When the user gets into the vehicle, the individual setting information is transmitted from both of the user terminal and the server device. That is, the first information is transmitted to the in-vehicle device from the user terminal owned by the user. Additionally, the second information is transmitted to the in-vehicle device from the server device. At this time, the first information is transmitted to the in-vehicle device from the user terminal through short-range wireless communication. That is, the first information is transmitted directly to the in-vehicle device from the user terminal. Additionally, the second Information is transmitted to the in-vehicle device from the server device through a network. Then, the in-vehicle device transmits the first information received from the user terminal and the second information received from the server device to an equipment control device that controls the pieces of equipment (pieces of equipment to be customized based on the first information and the second information) provided in the vehicle. When the equipment control device receives the first information or the second information, various settings in the pieces of equipment to be customized are customized to the settings corresponding to the user who has gotten into the vehicle, based on the received information.

Here, as described above, the first information is transmitted directly to the in-vehicle device from the user terminal by short-range wireless communication. Accordingly, the first information can be transmitted to the in-vehicle device more quickly as compared with a case where like the second information, the first information is transmitted to the in-vehicle device from the server device through the network. Therefore, in the vehicle, the customization of the pieces of equipment to be customized based on the first information can be completed at an earlier stage.

On the other hand, if not only the first information but also the second information are transmitted to the in-vehicle device from the user terminal by short-range wireless communication, not only the first information but also the second information need to be stored in the user terminal. In this case, the user terminal requires a very large storage capacity to store the individual setting information. Meanwhile, the individual setting information to be transmitted from the user terminal to the in-vehicle device is only the first information, and the second information is transmitted from the management server to the in-vehicle device, thereby making it possible to reduce the storage capacity of the user terminal required to store the individual setting information.

Hereinafter, specific embodiments of the present disclosure will be described with reference to the drawings. Dimensions, materials, and shapes of components described in the embodiments, relative arrangements thereof, and the like are not intended to limit the technical scope of the present disclosure only thereto unless otherwise noted.

### First Embodiment

In a vehicle, various settings in pieces of equipment mounted on the vehicle can be customized according to a user being a driver. On the other hand, like vehicles for ride sharing or rental vehicles, one vehicle may be used by a plurality of users in some cases. In such a case, it is desirable to customize various settings in pieces of equipment for each user (user as a driver) who uses the vehicle. Here, an embodiment will be described in which a system, an in-vehicle device, and an information processing method according to the present disclosure are applied to a system for customizing, for each user, various settings in pieces of equipment mounted on such a vehicle used by a plurality of users.

### Overview of System

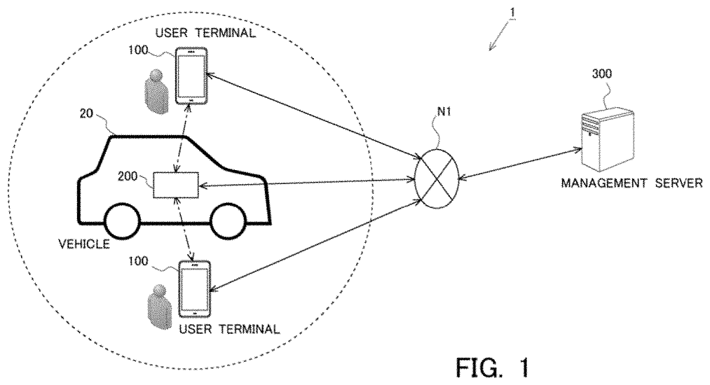

FIG. 1 is a diagram illustrating a schematic configuration of an information management system that manages individual setting information for customizing a vehicle, according to the present embodiment. An information management system 1 includes a user terminal 100 owned by each of a plurality of users, an in-vehicle device 200 mounted on a vehicle 20, and a management server 300. In the information management system 1, when a certain user has gotten into the vehicle 20, various settings in pieces of equipment provided in the vehicle 20 are customized to settings corresponding to a specific user who is the user having gotten into the vehicle 20, based on the individual setting information of the specific user.

In the information management system 1, each user terminal 100 and the in-vehicle device 200 are connected to the management server 300 through a network N1. As the network N1, for example, a wide area network (WAN) which is a global public communication network such as the Internet or a telephone communication network for mobile phones or the like may be employed. Communication is performed between each user terminal 100 and the in-vehicle device 200 by short-range wireless communication.

The user terminal 100 includes a computer including a processor, a main storage, an auxiliary storage, a communication interface (communication I/F), a short-range communication interface (short-range communication I/F), and an input/output interface (input/output I/F). As the user terminal 100, a smartphone, a tablet, computer, a mobile computer, or a wearable computer may be cited. A predetermined application for using the information management system 1 is executed in the user terminal 100. Additionally, first information which is a part of the individual setting information of a user carrying the user terminal 100 is stored in the user terminal 100. Note that the details of the first information will be described later.

The management server 300 includes a general computer. The computer constituting the management server 300 includes a processor, a main storage, an auxiliary storage, and a communication interface (communication I/F). Then, second information is stored in the management server 300, the second information serving as information other than the first information in the individual setting information of each user who uses the information management system 1. That is, the second Information about a plurality of users is stored in the management server 300. Note that the details of the second information will be described later.

The in-vehicle device 200 is a device that transmits the individual setting information of a specific user who is a user having gotten into the vehicle 20, to electronic control units (ECUs) that controls pieces of equipment provided in the vehicle 20, respectively. Here, the in-vehicle device 200 receives the first information in the individual setting information of the specific user from the user terminal 100 owned by the specific user. Additionally, the in-vehicle device 200 receives, from the management server 300, the second information in the individual setting information of the specific user. Then, the in-vehicle device 200 transmits, to the ECUs in the vehicle 20, the first information received from the user terminal 100 and the second information received from the management server 300.

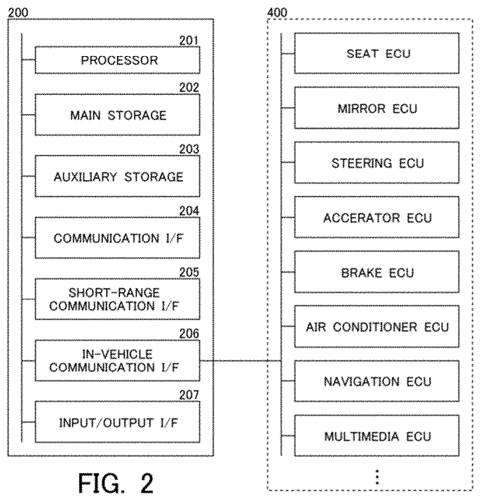

FIG. 2 is a diagram illustrating a schematic configuration of the in-vehicle device 200 and the ECUs in the vehicle 20. The in-vehicle device 200 includes a computer capable of being mounted on the vehicle 20. The computer constituting the in-vehicle device 200 includes a processor 201, a main storage 202, an auxiliary storage 203, a communication interface (communication I/F) 204, a short-range communication interface (short-range communication I/F) 205, an in-vehicle communication interface (in-vehicle communication I/F) 206, and an input/output interface (input/output I/F) 207.

Here, the processor 201 is a central processing unit (CPU) or a digital signal processor (DSP), for example. The main storage 202 is a random access memory (RAM), for example. The auxiliary storage 203 is a read only memory (ROM), a hard disk drive (HDD), or a flash memory, for example. Additionally, the auxiliary storage 203 may include a removable medium (removable recording medium). Here, the removable medium is, for example, a USB memory, an SD card, or a disc recording medium such as a CD-ROM, a DVD disc, or a Blu-ray disc.

The communication I/F 204 is an interface for connecting the in-vehicle device 200 to the network N1. The communication I/F 204 connects the in-vehicle device 200 to the network N1 using a predetermined wireless communication standard such as 3rd generation (3G) or long term evolution (LTE), for example. The communication X/F 204 includes, for example, a local area network (LAN) interface board or a wireless communication circuit for wireless communication.

The short-range communication I/F 205 is an interface through which the in-vehicle device 200 communicates directly with the user terminal 100 using a predetermined short-range wireless communication standard. As the predetermined short-range wireless communication standard, Bluetooth (registered trademark) Low Energy standard, WiFi (registered trademark), or the like may be cited.

The in-vehicle communication I/F 206 is an interface through which the in-vehicle device 200 communicates with another device provided in the vehicle 20 using a predetermined in-vehicle communication standard. As the predetermined in-vehicle communication standard, a controller area network (CAN), a local interconnect network (LIN), or the like may be cited. The in-vehicle device 200 is connected to the ECUs that control respective pieces of equipment provided in the vehicle 20 through the in-vehicle communication I/F 206. Here, the ECUs that communicate with the in-vehicle device 200 through the in-vehicle communication I/F 206 are ECUs that controls the respective pieces of equipment to be customized based on the individual setting information. As such ECUs, a seat ECU, a mirror ECU, a steering ECU, an accelerator ECU, a brake ECU, an air conditioner ECU, a navigation ECU, a multimedia ECU, and the like may be cited as illustrated in FIG. 2. Here, the seat ECU is an ECU that controls a seat in a vehicle cabin. The mirror ECU is an ECU that controls side mirrors and a rear view mirror. The steering ECU is an ECU that controls a steering wheel. The accelerator ECU is an ECU that controls an accelerator pedal. The brake ECU is an ECU that controls a brake pedal. The air conditioner ECU is an ECU that controls an air conditioner. The navigation ECU is an ECU that controls a navigation device. The multimedia ECU is an ECU that controls a multimedia player. Hereinafter, such ECUs that control the respective pieces of equipment to be customized based on the individual setting information are collectively referred to as an “equipment ECU” 400. In the present embodiment, the equipment ECU 400 corresponds to an “equipment control device” according to the present disclosure.

The input/output I/F 207 is an interface through which a user in the vehicle inputs the information and through which the information is output to the user in the vehicle. The input/output I/F 207 includes a touch panel display, for example.

In the in-vehicle device 200 having the above-described configuration, an operating system (OS), various programs, various information tables, and the like are stored in the auxiliary storage 203. The processor 201 loads a program stored in the auxiliary storage 203 into the main storage 202 and executes the loaded program, whereby processes for customizing the vehicle 20 which will be described later are implemented. However, some or all of the functions of the in-vehicle device 200 may be implemented by hardware circuits such as an ASIC and an FPGA. Note that, the in-vehicle device 200 does not necessarily have to be achieved by a single physical configuration and nay be formed by a plurality of computers operating in coordination.

### Individual Setting Information

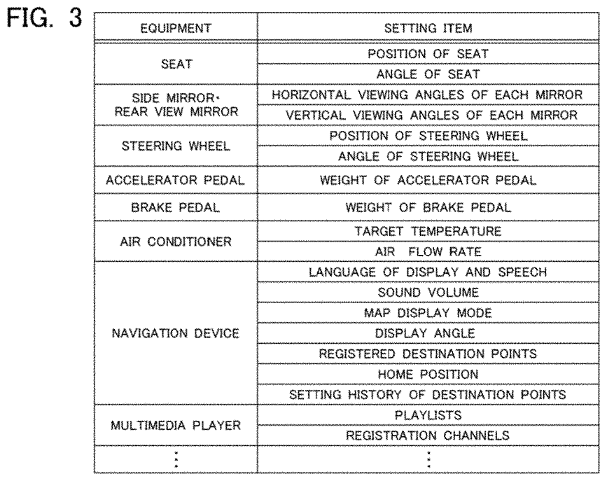

Here, a specific example of the individual setting information for customizing the vehicle 20 will be described with reference to FIG. 3. FIG. 3 is a diagram illustrating specific examples of pieces of equipment to be customized based on the individual setting information and setting items. As the pieces of equipment to be customized, the seat in the vehicle cabin, the side mirrors and rear view mirror, the steering wheel, the accelerator pedal, the brake pedal, the air conditioner, the navigation device, and the multimedia player that are to be controlled by the equipment ECU 400 illustrated in FIG. 2 may be cited as illustrated in FIG. 3. For the seat in the vehicle cabin, a position and angle of the seat may be cited as the setting items. For the side mirrors and rear view mirror, a horizontal viewing angle and vertical viewing angle of each mirror may be cited as the setting items. For the steering wheel, a position and angle of the steering wheel may be cited as the setting items. For the accelerator pedal, a weight of the accelerator pedal may be cited as the setting item. For the brake pedal, a weight of the brake pedal may be cited as the setting item. For the air conditioner, a target temperature and an air flow rate may be cited as the setting items. For the navigation device, language of display and speech, a sound volume, a map display mode, a display angle, a registered destination points, a home position, and a setting history of the destination points may be cited as the setting items. For the multimedia player, playlists and registered channels may be cited as the setting items.

The individual setting information of each user includes set values for each user with respect to the respective setting items of the pieces of equipment to be customized, as illustrated in FIG. 3. In the vehicle 20, the setting items of the pieces of equipment are controlled by the equipment ECU 400 based on the individual setting information of a specific user who has gotten into the vehicle 20. Thus, various settings in the pieces of equipment are customized to reflect the set values included in the individual setting information of the specific user.

In the information management system 1, the individual setting information of each user is divided into the first information and the second information, as described above. That is, among the plurality of setting items in the plurality pieces of equipment as illustrated in FIG. 3, the set values of some setting items are regarded as the first information, and the set values of the other setting items are regarded as the second information. At this time, the setting items included in the first information and the setting items included in the second information are predefined. That is, in the individual setting information, the information treated as the first information and the information treated as the second information are predefined. Specifically, the information (set values) about the setting items, the customization of which is desired to be completed at a relatively earlier stage when the user has gotten into the vehicle 20, is defined as the first information. However, in the individual setting information of one user, the first information and the second information are defined so that the total data capacity of the second information is larger than the total data capacity of the first information.

In the information management system 1, the first information of each user is stored in the user terminal 100 owned by each user. The second information of each user is stored in the management server 300. In this way, in the information management system 1, the in-vehicle device 200 receives the first information stored in one or a plurality of the user terminals 100 existing in a predetermined range from the vehicle 20, directly therefrom by short-range wireless communication. Here, the predetermined range is a range in which short-range wireless communication can be performed between the in-vehicle device 200 and the user terminal 100. Note that in FIG. 1, a range enclosed by a dashed line indicates the predetermined range. That is, the in-vehicle device 200 receives the first information not only from the user terminal 100 owned by a user who is going to get into the vehicle 20 but also from the user terminal 100 owned by each of the other users existing around the vehicle 20. Additionally, the in-vehicle device 200 receives the first information from the user terminal 100 owned by the user who actually gets into the vehicle 20, at the point in time before the user gets into the vehicle 20. Furthermore, the in-vehicle device 200 stores the first information received from one or the plurality of user terminals 100 in an individual setting information database which will be described later.

Furthermore, the in-vehicle device 200 performs an authentication process of specifying a specific user who is a user having gotten into the vehicle 20. Then, the in-vehicle device 200 selects the first information corresponding to the specific user specified by the authentication process out of the first information stored in the individual setting information database, and transmits the selected first information to the equipment ECU 400. Hereby, the pieces of equipment to be customized are customized by the equipment ECU 400 based on the first information. Additionally, the in-vehicle device 200 receives the second information corresponding to the specific user from the management server 300, and transmits the received second information to the equipment ECU 400. Hereby, the pieces of equipment to be customized are customized by the equipment ECU 400 based on the second information.

### Functional Configuration

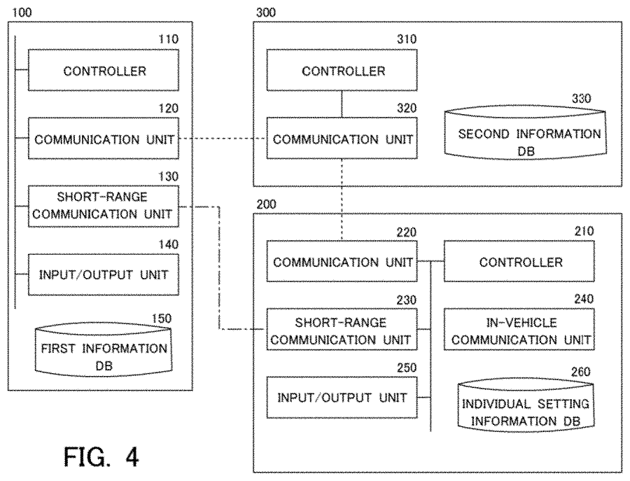

Next, functional configurations of the user terminal 100, the in-vehicle device 200, and the management server 300 that constitute the information management system 1 according to the present embodiment will be described with reference to FIG. 4. FIG. 4 is a block diagram schematically illustrating an example of a functional configuration of each of the user terminal 100, the in-vehicle device 200, and the management server 300.

### User Terminal

The user terminal 100 includes a controller 110, a communication unit 120, a short-range communication unit 130, an input/output unit 140, and a first information database (first information DB) 150. The controller 110 has a function of performing an arithmetic process of controlling the user terminal 100. The controller 110 can be implemented by the processor.

The communication unit 120 has a function of connecting the user terminal 100 to the network N1. The communication unit 120 includes a communication I/F. The communication unit 120 can communicate with the management, server 300 through the network N1 using mobile communication service. Then, the controller 110 performs a process of transmitting a user ID for identifying the specific user having gotten into the vehicle 20 to the management server 300 via the communication unit 120, as described later.

The short-range communication unit 130 has a function of communicating with the in-vehicle device 200 when the user terminal 100 exists in the predetermined range from the vehicle 20. The short-range communication unit 130 includes a short-range communication I/F. The short-range communication I/F included in the short-range communication unit 130 is an interface that performs communication using the same short-range wireless communication standard as that of the short-range communication I/F 205 in the in-vehicle device 200. The controller 110 performs a process of transmitting the first information of the user carrying the user terminal 100 to the in-vehicle device 200 via the short-range communication unit 130, when the user terminal 100 exists in the predetermined range from the vehicle 20. At this time, the controller 110 transmits, to the in-vehicle device 200, the user 10 for identifying the user carrying the user terminal 100 and a personal identification number (PIN) code associated with the user terminal 100 together with the first information. Note that in the user terminal 100, the first information of the user carrying the user terminal 100 is stored in advance in the first information DB 150. The first information DB 150 is constructed in the auxiliary storage of the user terminal 100.

The input/output unit 140 has a function of receiving input of the information and a function of outputting the information. The input/output unit 140 includes an input/output I/F such as a camera and a touch panel display. Then, the controller 110 performs a process of inputting or outputting necessary information via the input/output, unit 140, when performing the authentication process of specifying the specific user, which will be described later.

### In-Vehicle Device

The in-vehicle device 200 includes a controller 210, a communication unit 220, a short-range communication unit 230, an in-vehicle communication unit 240, an input/output unit 250, and an individual setting information database (individual setting information DB) 260. The controller 210 has a function of performing an arithmetic process of controlling the in-vehicle device 200. Additionally, the controller 210 has a function of performing an authentication process of specifying a specific user. The controller 210 can be implemented by the processor 201.

The communication unit 220 has a function of connecting the in-vehicle device 200 to the network N1. The communication unit 220 includes a communication I/F 204. The communication unit 220 can communicate with the management server 300 through the network N1. Then, the controller 210 performs a process of receiving the second information of the specific user having gotten into the vehicle 20 from the management server 300 via the communication unit 220.

The short-range communication unit 230 has a function of communicating with the user terminal 100 when the user terminal 100 exists in the predetermined range from the vehicle 20. The short-range communication unit 230 includes a short-range communication I/F 205. Then, the controller 210 performs a process of receiving, from the user terminal 100, the first information of the user carrying the user terminal 100, the user ID for identifying the user, and the PIN code associated with the user terminal, when the user terminal. 100 exists in the predetermined range from the vehicle 20.

The controller 210 performs a process of storing, in the individual setting information DB 260, the first information, the user ID, and the PIN code that are received from each user terminal 100, in a state of being associated with one another. Furthermore, the controller 210 performs a process of storing, in the individual setting information DB 260, the second information of the specific user received from the management server 300. Hereby, the first information received from each user terminal 100 and the second information received from the management server 300 are stored in the individual setting information DB 260. Note that, the controller 210 stores, in the individual setting information DB 260, the second information of the specific user in a state of being associated with the user ID of the specific user. Thus, in the individual setting information DB 260, the first information and second information of the specific user, the user ID of the specific user, and the PIN code of the user terminal 100 owned by the specific user are stored in a state of being associated with one another. Note that the individual setting information DB 260 is constructed in the auxiliary storage 203 by the processor 201 executing programs of the database management system.

The in-vehicle communication unit 240 has a function of communicating with the equipment ECU 400 in the vehicle 20. The in-vehicle communication unit 240 includes an in-vehicle communication I/F 206. Here, the controller 210 performs a process of selecting the first information corresponding to the specific user out of the first information stored in the individual setting information DB 260, when specifying the specific user by the authentication process. Then, the controller 210 performs a process of transmitting the selected first information (the first information of the specific user) to the equipment ECU 400 via the in-vehicle communication unit 240. Additionally, the controller 210 performs a process of transmitting the second information of the specific user received from the management server 300, to the equipment ECU 400 via the in-vehicle communication unit 240.

The input/output unit 250 has a function of receiving input of the information and a function of outputting the information. The input/output, unit 250 includes an input/output I/F 207. Then, the controller 210 performs a process of inputting or outputting necessary information via the input/output unit 250, when performing the authentication process of specifying the specific user, which will be described later.

### Management Server

The management server 500 includes a controller 310, a communication unit 320, and a second information database (second information DB) 330. The controller 310 has a function of performing an arithmetic process of controlling the management server 300. The controller 310 can be implemented by the processor.

The communication unit 320 has a function of connecting the management server 300 to the network N1. The communication unit 320 includes a communication I/F. The communication unit 320 can communicate with the user terminal 100 and the in-vehicle device 200 through the network N1. Then, the controller 310 performs a process of receiving the user ID for identifying the specific user having gotten into the vehicle 20 from the in-vehicle device 200 via the communication unit 320, as described later.

The second information of each user is stored in advance in a second information DB 330, in a state of being associated with the user ID. Then, the controller 310 performs a process of selecting the second information corresponding to the user ID of the specific user out of the second information stored in the second information DB 330, when receiving the user ID of the specific user from the in-vehicle device 200. Furthermore, the controller 310 performs a process of transmitting the selected second information to the in-vehicle device 200 via the communication unit 320. The second information DB 330 is constructed in the auxiliary storage of the management, server 300.

### Information Process Flow

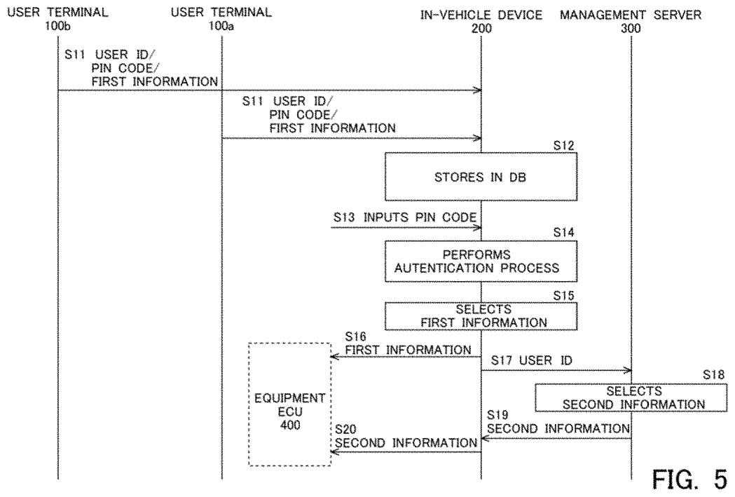

Hereinafter, an information process flow in the information management system 1 according to the present embodiment, will be described with reference to FIG. 5. FIG. 5 is a sequence diagram illustrating an information process flow in the information management system 1 according to the present embodiment. Note that in FIG. 5, two user terminals 100 existing in the predetermined range from the vehicle 20 are represented by a user terminal 100a and a user terminal 100b.

In the present embodiment, the in-vehicle device 200 receives the first information, the user ID, and the PIN code from each of the user terminals 100 (100a and 100b) existing in the predetermined range from the vehicle 20, by short-range wireless communication (S11). Then, the in-vehicle device 200 stores, in the individual setting information DB 260, the first information, the user ID, and the PIN code that are received from each of the user terminals 100 (S12). At the point in time when the process of S12 is performed, the user to be specified as a specific user has not gotten into the vehicle 20 yet. Additionally, the first information of the other users who do not actually get into the vehicle 20 is also stored in the individual setting information DB 260, the other users existing around the vehicle 20.

Then, when the specific user gets into the vehicle 20, the PIN code of the user terminal 100 owned by the specific user is input to the input/output I/F 207 of the in-vehicle device 200 by the specific user (S13). Note that, at this time, the PIN code may be displayed on the input/output I/F of the user terminal 100 owned by the specific user. In this case, the specific user may input the PIN code to the input/output I/F 207 of the in-vehicle device 200 with reference to the PIN code displayed on the user terminal 100 owned by the specific user. Additionally, the specific user may cause the input/output I/F 207 of the in-vehicle device 200 to read the PIN code displayed on the user terminal 100 owned by the specific user.

When the PIN code is input to the input/output I/F 207 by the specific user, the in-vehicle device 200 performs the authentication process of specifying the specific user (S14). The authentication process is performed based on the PIN code input by the specific user. Specifically, among users whose first information is stored in the individual setting information DB 260, a user associated with the sane PIN code as the PIN code input to the input/output I/F 207 is determined as the specific user. Then, in the in-vehicle device 200, the first information of the specific user specified by the authentication process is selected out of the first information stored in the individual setting information DB 260 (S15). That is, the first information associated with the same PIN code as the PIN code input to the input/output I/F 207 is selected as the first information of the specific user. Furthermore, the in-vehicle device 200 transmits the selected first information (the first information of the specific user) to the equipment ECU 400 (S16). Note that, in the in-vehicle device 200, when the specific user is specified by the authentication process, the information (the first information, the user IDs, and the PIN codes) corresponding to the users other than the specific user that is temporarily stored in the individual setting information DB 260 is delated from the individual setting information DB 260. The process of deleting the information corresponding to the users other than the specific user from the individual setting information DB 260 in the in-vehicle device 200 is performed by the controller 210. This can prevent unnecessary information from remaining stored in the individual setting information DB 260.

When the specific user is specified by the authentication process, the in-vehicle device 200 transmits the user ID (the user ID associated with the same PIN code as the PIN code input to the input/output I/F 207) of the specific user stored in the individual setting information DB 260 from the in-vehicle device 200 to the management server 300 through the network N1 (S17). In the management server 300, when the user ID of the specific user is received, the second information corresponding to the user ID of the specific user is selected out of the second information stored in the second information DB 330 (S18). That is, the second information associated with the same user ID with the user ID received from the in-vehicle device 200 is selected as the second information of the specific user. Furthermore, the management server 300 transmits the selected second information (the second information of the specific user) to the in-vehicle device 200 through the network N1 (S19). Then, the in-vehicle device 200 transmits, to the equipment ECU 400, the second information of the specific user received from the management server 300 (S20).

### Effect by This System

As described above, in the information management system 1, the individual setting information of each user used for customizing the vehicle 20 is divided into the first information and the second information. The first information is stored in the user terminal 100, the first information serving as information about the setting items, the customization of which is desired to be completed at a relatively earlier stage when the user has gotten into the vehicle 20. In this way, when the user gets into the vehicle 20, the first information is transmitted directly to the in-vehicle device 200 from the user terminal 100 by short-range wireless communication. On the other hand, the second information is transmitted to the in-vehicle device 200 from the management server 300 through the network N1.

Therefore, when the user gets into the vehicle 20, the first information is transmitted to the in-vehicle device 200 more quickly than the second information. Accordingly, the first information can be transmitted to the in-vehicle device 200 more quickly as compared with a case where like the second information, the first information is transmitted to the in-vehicle device 200 from the management server 300 through the network N1. Therefore, in the vehicle 20, the customization of the pieces of equipment to be customized based on the first information can be completed at an earlier stage. That is, according to the information management system 1, the customization of the pieces of equipment to be customized based on a part (first information) of the individual setting information can be completed at an earlier stage as compared with a case where all of the individual setting information including the first information and the second information is transmitted to the in-vehicle device 200 from the management server 300.

On the other hand, if not only the first information but also the second information are transmitted to the in-vehicle device 200 from the user terminal 100 by short-range wireless communication, not only the first information but also the second information need to be stored in the user terminal. In this case, the user terminal 100 requires a very large storage capacity to store the individual setting information. Meanwhile, in the information management system 1, the individual setting information to be transmitted from the user terminal 100 to the in-vehicle device 200 is only the first information, and the second information is transmitted from the management server 300 to the in-vehicle device 200, thereby making it possible to reduce the storage capacity of the user terminal 100 required to store the individual setting information. Additionally, as described above, in the individual setting information of one user, the total data capacity of the second information is larger than the total data capacity of the first information. Thus, when the total data capacity of the first, information is reduced, the storage capacity of the user terminal 100 required to store the first information can be further reduced.

Furthermore, in the information management system 1, the in-vehicle device 200 receives, from one or a plurality of the user terminals 100 existing in a predetermined range from the vehicle 20, the first information stored therein. Therefore, the first information of the specific user is stored in the individual setting information DB 260, at the point in time before the user who is going to get into the vehicle 20 actually gets into the vehicle 20. Then, when the specific user gets into the vehicle 20, the first information of the specific user stored in the individual setting information DB 260 is transmitted to the equipment ECU 400. As a result, various settings in the pieces of equipment mounted on the vehicle 20 are customized based on the first information of the specific user. Accordingly, the first information can be supplied to the equipment ECU 400 at an earlier stage as compared with a case where the first information of the specific user is transmitted to the vehicle after the specific user gets into the vehicle 20. As a result, the customization of the vehicle 20 based on the first information can be completed at an earlier stage.

In the present embodiment, the authentication process of specifying the specific user is performed based on the PIN code input to the in-vehicle device 200 by the specific user. The first information corresponding to the specific user specified by the authentication process is selected out of the first information stored in the individual setting information DB 260, and the selected first information is transmitted to the equipment ECU 400. Performing such an authentication process enabled the in-vehicle device 200 to grasp the specific user even when the information for identifying the user terminal 100 owned by the user to be specified as the specific user is not registered in advance with the in-vehicle device 200. Accordingly, the first information corresponding to the specific user can be transmitted to the equipment ECU 400. Note that an input code to be input to the in-vehicle device 200 for the authentication process is not necessarily limited to the PIN code. That is, the input code to be input to the in-vehicle device 200 is a code to be transmitted from the user terminal 100 to the in-vehicle device 200 together with the first information, the code being associated with the user ID.

### Modified Embodiment 1

In the information management system 1, each user terminal 100 may transmit the first information in an encrypted state to the in-vehicle device 200. In this case, the in-vehicle device 200 stores the encrypted first information in the individual setting information DB 260. Then, in the in-vehicle device 200, when the specific user is specified by the authentication process, the controller 210 selects the first information of the specific user out of the first information stored in the individual setting information DB 260, and decrypts the selected first information. Furthermore, the controller 210 transmits the decrypted first information of the specific user to the equipment ECU 400. In this case, the controller 210 deletes, from the individual setting information DB, the first information of users other than the specific user stored therein in an encrypted state, without decrypting it. Thus, the encrypted first information is transmitted from each user terminal 100, whereby security of the first information can be improved

### Modified Embodiment 2

As described above, in the information management system 1, when the specific user is specified by the authentication process, the information corresponding to users other than the specific user that is temporarily stored in the individual setting information DB 260 of the in-vehicle device 200 is deleted from the individual setting information DB 260. On the other hand, the information corresponding to the user specified as the specific user may be continuously stored in the individual setting information DB 260. In this case, in a case where one user is specified as the specific user to use the vehicle 20 and thereafter another user is specified as the specific user to use the same vehicle 20 the individual setting information corresponding to the one user and the individual setting information corresponding to the other user are stored in the individual setting information DB 260.

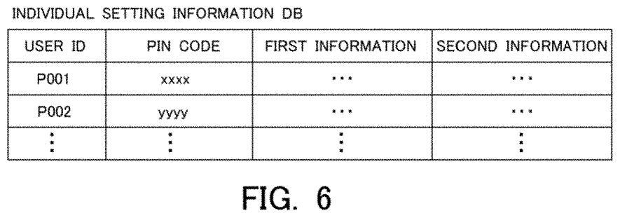

FIG. 6 is a table illustrating an example of a table configuration of the individual setting information DB 260 storing the user ID, the PIN code (PIN code of the user terminal 100 owned by the user), the first information and the second information of each of the users specified as the specific users. As illustrated in FIG. 6, in the individual setting information DB 260, the user ID, the PIN code, the first information and the second information corresponding to each of users who have been specified as the specific users of the vehicle 20 so far are stored in a state of being associated with one another. Note that an upper limit value of the number of users each indicated by these information items that cars be continuously stored in the individual setting information DB 260 may be set in advance.

In a case where the user (i.e., the user who has beers specified as the specific user in the past) corresponding to the user ID stored in the individual setting information DB 260 has gotten into the vehicle 20 again, the first information and the second information of the user that are stored in the individual setting information DB 260 are transmitted to the equipment ECU 400 from the in-vehicle device 200. At this time, in the in-vehicle device 200, when the specific user is specified by the authentication process, the controller 210 determines whether the information related to the specific user is stored in the individual setting information DB 260. This determination is made based on whether the same user ID (or the BIN code) as the user ID (or the PIN code) of the specific user specified this time is already stored in the individual, setting information DB 260.

In a case where it is determined that the information related to the specific user is stored in the individual setting information DB 260, the controller 210 transmits, to the equipment ECU 400, the first information and the second information that are stored in the individual setting information DB 260 in a state of being associated with the user ID (or the BIN code) of the specific user. Note that in this case, the communication is not performed between the in-vehicle device 200 and the management server 300 after the authentication process is performed, that is, the processes of S17, S18, and S19 in FIG. 5 are not performed.

As described above, in a case where the user who has been specified as the specific user in the past has gotten into the vehicle 20 again, the second information of the user can be supplied to the equipment ECU 400 from the in-vehicle device 200 without the necessity of receiving the second information from the management server 300. Therefore, not only the customization of the vehicle 20 based on the first information but also the customization of the vehicle 20 based on the second information can be completed at an earlier stage.

### Second Embodiment

A schematic configuration of an information management, system according to the present embodiment is the same as that in the first embodiment. However, the present embodiment is different from the first embodiment in the contents of the authentication process of specifying a specific user that is performed in the in-vehicle device 200.

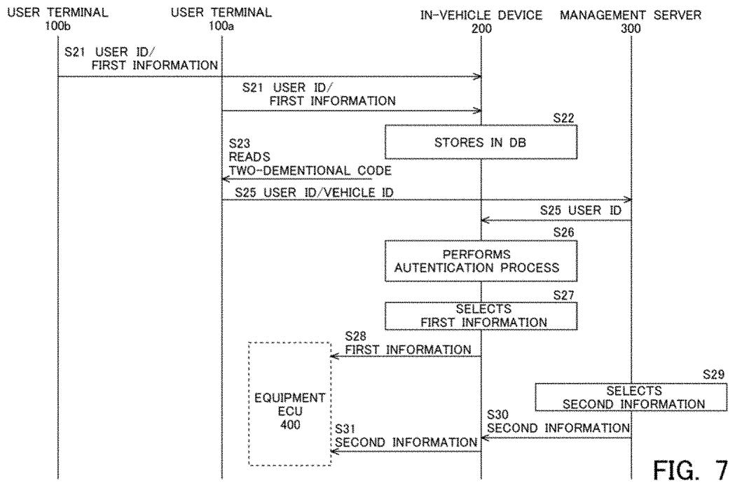

Hereinafter, an information process flow in an information management system 1 according to the present embodiment will be described with reference to FIG. 7. FIG. 7 is a sequence diagram illustrating an information process flow in the information management system 1 according to the present embodiment. Note that also in FIG. 7, two user terminals 100 existing in a predetermined range from a vehicle 20 are represented by a user terminal 100a and a user terminal 100b, similarly to FIG. 5. In FIG. 7, the user terminal 100a is a user terminal 100 owned by the user to be specified as a specific user.

In the present embodiment, an in-vehicle device 200 receives first information and a user ID from each of the user terminals 100 (100a and 100b) existing in the predetermined range from the vehicle 20, by short-range wireless communication (S21). Then, the in-vehicle device 200 stores, in an individual setting information DB 260, the first information and the user ID that are received from each of the user terminals 100 (S22). As in the first embodiment, at the point in time when the process of S22 is performed, the user to be specified as a specific user has not gotten into the vehicle 20 yet. Additionally, the first information of the other users who do not actually get into the vehicle 20 is also stored in the individual setting information DB 260, the other users existing around the vehicle 20.

Then, when the specific user gets into the vehicle 20, a two-dimensional code (e.g., QR code (registered trademark)) including a vehicle ID for identifying the vehicle 20 is displayed on an input/output I/F 207 of the in-vehicle device 200. When the two-dimensional code is displayed on the input/output I/F 207, the two-dimensional code is read by an input/output I/F of the user terminal 100a owned by the specific user who has gotten into the vehicle 20 (S23). Thus, the user terminal 100a owned by the specific user acquires the vehicle ID.

Note that the process of displaying the two-dimensional code on the input/output I/F 207 of the in-vehicle device 200 is performed by a controller 210. The display code displayed on the input/output I/F 207 is not necessarily limited to the two-dimensional code. That is, the display code to be displayed on the input/output I/F 207 is a code including the vehicle ID, the code being a code being able to be read by the user terminal 100.

When the user terminal 100a owned by the specific user acquires the vehicle ID, the user terminal 100a transmits the user ID (the user ID of the specific user) and the vehicle ID to the management server 300 through the network N1 (S24). When the management server 300 receives the user ID and the vehicle ID from the user terminal 100a, the management server 300 specifies the vehicle 20 that the specific user has gotten into, based on the vehicle ID. Then, the management server 300 transmits the user ID received from the user terminal 100a, to the in-vehicle device 200 mounted on the specified vehicle 20 through the network N1 (S25).

When the in-vehicle device 200 receives the user ID transmitted from the management server 300, in the in-vehicle device 200, the authentication process of specifying the specific user is performed (S26). The authentication process is performed based on the user ID received from the management server 300. Specifically, among users whose first information is stored in the individual setting information DB 260, a user corresponding to the same user ID as the user ID received from the management server 300 is determined as the specific user. Then, in the in-vehicle device 200, the first information of the specific user specified by the authentication process is selected out of the first information stored in the individual setting information DB 260 (S27). That is, the first information associated with the same user ID as the user ID received from the management server 300 is selected as the first information of the specific user. Furthermore, the in-vehicle device 200 transmits the selected first information (the first information of the specific user) to the equipment ECU 400 (S27). Note that, in the in-vehicle device 200, as in the first embodiment, when the specific user is specified by the authentication process, the information (the first information, and the user IDs) corresponding to the users other than the specific user that is temporarily stored in the individual setting information DB 260 is deleted from the individual setting information DB 260.

In the management server 300, the second information corresponding to the user ID of the specific user is selected out of the second information stored in the second information DB 330 (S29). That is, the second information associated with the same user ID with the user ID received from the user terminal 100a is selected as the second information of the specific user. Furthermore, the management server 300 transmits the selected second information (the second information of the specific user) to the in-vehicle device 200 through the network N1 (S30). Then, the in-vehicle device 200 transmits, to the equipment ECU 400, the second information of the specific user received from the management server 300 (S31). Note that, in the present embodiment, the user ID corresponds to “user identification information” according to the present disclosure, and the vehicle ID corresponds to “vehicle identification information” according to the present disclosure.

Also in the present embodiment, performing the above-descried authentication process in the in-vehicle device 200 enables the in-vehicle device 200 to grasp the specific user even when the information for identifying the user terminal 100 owned by the user to be specified as the specific user is not registered in advance with the in-vehicle device 200. Therefore, the first information corresponding to the specific user can be transmitted to the equipment ECU 400.

Additionally, also in the present embodiment, the effects by the information management system 1 can be obtained, as in the first, embodiment. Furthermore, Modified Embodiment 1 and Modified Embodiment 2 of the first embodiment as described above can be also applied to the second embodiment.

### Other Embodiments

One skilled in the art will understand Chat the above-described embodiments are examples, and the present disclosure can be implemented with changes made as appropriate without departing from the spirit of the present disclosure. For example, the processing and units described in the present disclosure can be implemented by being freely combined unless technical conflicts arise.

Moreover, the processing described as processing to be performed by a single apparatus may be performed by several apparatuses in a shared manner. Alternatively, the processing described as processing to be performed by different apparatuses may be performed by a single apparatus. As those skilled in the art will recognize, a computer system can be flexibly changed according to the hardware component (server component) used to implement each function.

The present disclosure can also be implemented by providing a computer program designed to implement the functions described in the above embodiments to a computer, and by one or more processors included in the computer for reading and executing the program. Such a computer program may be provided to the computer, for example, by using a non-transient computer-readable storage medium that can be connected to a system bus of the computer, or may be provided to the computer via a network. Examples of the non-transient computer-readable storage medium include any types of disks/discs such as magnetic disks (floppy(R) disk, hard disk drive (HDD), and the like) and optical discs (CD-ROM, DVD disc, Blu-ray Disc, and the like), read-only memory (ROM), random access memory (RAM), EPROM, EEPROM, magnetic card, flash memory, optical card, and any other type of media suitable for storing therein electronic instructions.

What is claimed is:

1. A system, comprising: a user terminal; a server device; and an in-vehicle device mounted on a vehicle,
wherein first information which is a part of individual setting information of a user related to pieces of equipment provided in the vehicle is stored in the user terminal owned by the user,
second information other than the first information in the individual setting information is stored in the server device,
the user terminal transmits the first information to the in-vehicle device by short-range wireless communication,
the server device transmits the second information to the in-vehicle device through a network, and
the in-vehicle device transmits the first information received from the user terminal and the second information received from the server device to an equipment control device that controls the pieces of equipment provided in the vehicle.

2. The system according to claim 1, wherein
in the individual setting information, a total data capacity of the second information is larger than a total data capacity of the first information.

3. The system according to claim 1, wherein
the in-vehicle device
stores, in a storage, the first information received from the user terminal and the second information received from the server device in a state of being associated with user identification information for identifying a user corresponding to the first information and the second information; and
transmits, to the equipment control device, the first information and the second information that are associated with the user identification information and that are stored in the storage, in a case where a user corresponding to the user identification information stored in the storage gets into the vehicle again.

4. The system according to claim 1, wherein
the in-vehicle device
receives, from one or a plurality of user terminals existing in a predetermined range from the vehicle, the first information stored in each of the user terminals, and stores the first information in a storage,
performs an authentication process of specifying a specific user who is a user getting into the vehicle,
selects the first information corresponding to the specific user specified by the authentication process out of the first information stored in the storage, and
transmits the selected first information to the equipment control device.

5. The system according to claim 4, wherein
in the authentication process, the in-vehicle device specifies the specific user getting into the vehicle, based on an input code input by the specific user.

6. The system according to claim 4, wherein
the user terminal owned by the specific user acquires vehicle identification information for identifying the vehicle from the in-vehicle device, and transmits, to the server device, user identification information for identifying the specific user and the vehicle identification information,
the server device specifies the vehicle based on the vehicle identification information, and transmits, to the in-vehicle device, the user identification information of the specific user, and
in the authentication process, the in-vehicle device specifies the specific user based on the user identification information received from the server device.

7. The system according to claim 6, wherein
a display code including the vehicle identification information and displayed in the vehicle by the in-vehicle device, is read by the user terminal, so that the user terminal acquires the vehicle identification information.

8. The system according to claim 4, wherein
the in-vehicle device receives, from the server device, the second information corresponding to the specific user specified by the authentication process.

9. An in-vehicle device mounted on a vehicle, comprising:
a controller configured to perform:
receiving first information which is a part of individual setting information of a user related to pieces of equipment provided in the vehicle from a user terminal owned by the user by short-range wireless communication;
receiving second information other than the first information in the individual setting information from a server device through a network; and
transmitting the first information received from the user terminal and the second information received from the server device to an equipment control device that controls the pieces of equipment provided in the vehicle.

10. The in-vehicle device according to claim 9, wherein
in the individual setting information, a total data capacity of the second information is larger than a total data capacity of the first information.

11. The in-vehicle device according to claim 9, wherein
the controller further performs:
storing, in a storage, the first information received from the user terminal and the second information received from the server device in a state of being associated with user identification information for identifying a user corresponding to the first information and the second information; and
transmitting, to the equipment control device, the first information and the second information that are associated with the user identification information and that are stored in the storage, in a case where a user corresponding to the user identification information stored in the storage gets into the vehicle again.

12. The in-vehicle device according to claim 9, wherein
the controller further performs:
receiving, from one or a plurality of user terminals existing in a predetermined range from the vehicle, the first information stored in each of the user terminals, and storing the first information in a storage;
performing an authentication process of specifying a specific user who is a user getting into the vehicle;
selecting the first, information corresponding to the specific user specified by the authentication process out of the first information stored in the storage; and
transmitting the selected first information to the equipment control device.

13. The in-vehicle device according to claim 12, wherein
in the authentication process, the controller specifies the specific user getting into the vehicle, based on an input code input by the specific user.

14. The in-vehicle device according to claim 12, wherein
the server device receives, from the user terminal owned by the specific user, the vehicle identification information for identifying the vehicle and the user identification information for identifying the specific user, and specifies the vehicle based on vehicle identification information, and
the controller
further performs receiving the user identification information of the specific user transmitted from the server device, and
specifies, in the authentication process, the specific user based on the user identification information received from the server device.

15. The in-vehicle device according to claim 14, wherein
the controller further performs displaying, in the vehicle, a display code read using the user terminal by the specific user getting into the vehicle, the display code including the vehicle identification information.

16. The in-vehicle device according to claim 12, wherein
the controller further performs receiving, from the server device, the second information corresponding to the specific user specified by the authentication process.

17. An information processing method performed by a computer in a system comprising: a user terminal; a server device; and an in-vehicle device mounted on a vehicle, the method comprising:
transmitting first information which is a part of individual setting information of a user related to pieces of equipment provided in the vehicle to the in-vehicle device from the user terminal owned by the user by short-range wireless communication;
transmitting second information other than the first information in the individual setting information from the server device to the in-vehicle device through a network; and
causing the in-vehicle device to transmit the first information received from the user terminal and the second information received from the server device, to an equipment control device that controls the pieces of equipment provided in the vehicle.

18. The information processing method according to claim 17, further comprising:
causing the in-vehicle device to store, in a storage, the first information received from the user terminal and the second information received from the server device in a state of being associated with user identification information for identifying a user corresponding to the first information and the second information; and
transmitting, to the equipment control device, the first information and the second information that are associated with the user identification information and that are stored in the storage, in a case where a user corresponding to the user identification information stored in the storage gets into the vehicle again.

19. The information processing method according to claim 17, further comprising:
causing the in-vehicle device to receive, from one or a plurality of user terminals existing in a predetermined range from the vehicle, the first information stored in each of the user terminals, and to store the first information in a storage;
performing an authentication process of specifying a specific user who is a user getting into the vehicle;
selecting the first information corresponding to the specific user specified by the authentication process out of the first information stored in the storage; and
transmitting the selected first information to the equipment control device.

20. The information processing method according to claim 19, further comprising:
causing the in-vehicle device to receive, from the server device, the second information corresponding to the specific user specified by the authentication process.
